(19) United States
(12) Patent Application Publication
(10) Pub. No.: US 2026/0171637 A1
(43) Pub. Date: Jun. 18, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Tae Gyeom Lee, Suwon-si, Gyeonggi-do (KR); Taehoon Kim, Suwon-si, Gyeonggi-do (KR); Kwangjik Lee, Suwon-si, Gyeonggi-do (KR); Han Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/711,437

(22) PCT Filed: Apr. 24, 2024
(86) PCT No.: PCT/KR2024/005522

§ 371 Date: May 17, 2024

(30) Foreign Application Priority Data
Oct. 17, 2023 (KR) 10-2023-0139002

(51) Int. Cl. H01M 50/586

(52) U.S. Cl. CPC H01M 50/586

(57) ABSTRACT

An all-solid-state battery according to an embodiment includes: a cell laminate including a solid electrolyte layer; a positive electrode layer and a negative electrode layer disposed with the solid electrolyte layer interposed therebetween; and margin layers disposed at edges of the positive electrode layer and the negative electrode layer in a lateral direction, wherein the margin layer includes aluminosilicate particles (Al₂SiO₅), the margin layer includes ceramic glass that does not contain lithium, and the aluminosilicate particles are included in an amount of 10 vol % to 70 vol % based on the entire volume of the margin layer.

### CROSS-REFERENCE TO RELATED APPLICATION

This application claims priority to and the benefit of Korean Patent Application No. 10-2023-0139002 filed in the Korean Intellectual Property Office on Oct. 17, 2023, the entire contents of which are incorporated herein by reference.

### BACKGROUND

The present disclosure relates to an all-solid-state battery.

Recently, as the miniaturization of portable electronic devices and the use of the portable electronic devices for a long time have been required, an increase in capacity of batteries has been required, and in accordance with the spread of wearable electronic devices, it has been required to ensure safety of the batteries. Accordingly, the development of all-solid-state batteries that use solid electrolytes instead of liquid electrolytes has been actively conducted.

The all-solid-state battery does not use a flammable organic solvent, such that an additional circuit for safety may be simplified. Accordingly, the all-solid-state battery has been expected as a technology capable of manufacturing a safe battery having high capacity per unit volume.

In addition, an oxide all-solid-state battery using an oxide electrolyte has ionic conductivity (10⁻⁴ S/cm to 10⁻⁶ S/cm) of the electrolyte lower than ionic conductivity (10⁻² S/cm) of sulfide and requires a high-temperature sintering process, but has stability superior to that of a sulfide all-solid-state battery that uses a sulfide electrolyte reacting with oxygen and moisture in the air.

A multilayer oxide all-solid-state battery is an ultra-small battery that may be mounted on a substrate like a passive element, and is stable even though it is exposed to a high temperature in a reflow process for mounting the multilayer oxide all-solid-state battery on the substrate.

When the multilayer all-solid-state battery is manufactured, when electrode layers and solid electrolyte layer green sheets are pressed, the problem that a laminate is bent may occur. When the laminate is bent, there is a problem that electrodes are bent to cause a short-circuit of the battery, and therefore, a demand for an all-solid-state battery for preventing such a problem has increased.

### SUMMARY

The present disclosure attempts to provide an all-solid-state battery capable of preventing electrodes from being bent while maintaining insulation and moisture resistance properties.

However, the problems that the embodiments are intended to address are not limited to the problems described above and may be expanded in various ways within the scope of the technical ideas included in the embodiments.

An all-solid-state battery according to an embodiment includes: a cell laminate including a solid electrolyte layer; a positive electrode layer and a negative electrode layer disposed with the solid electrolyte layer interposed therebetween; and margin layers disposed at edges of the positive electrode layer and the negative electrode layer in a lateral direction, wherein the margin layer includes aluminosilicate particles (Al₂SiO₅) and ceramic glass that does not contain lithium, and the aluminosilicate particles are included in an amount of 10 vol % to 70 vol % based on the entire volume of the margin layer.

An all-solid-state battery according to another embodiment includes: a cell laminate including a solid electrolyte layer; a positive electrode layer and a negative electrode layer disposed with the solid electrolyte layer interposed therebetween; and margin layers disposed at edges of the positive electrode layer and the negative electrode layer in a lateral direction, and a cover layer disposed on one surface or both surfaces of the cell laminate in a stacking direction, wherein the margin layer or the cover layer includes aluminosilicate particles (Al₂SiO₅) and ceramic glass that does not contain lithium, and the aluminosilicate particles are included in an amount of 10 vol % to 70 vol % based on the entire volume of the margin layer or the entire volume of the cover layer.

The all-solid-state battery according to the embodiment has the advantage of being able to prevent bending of the electrode while maintaining insulation and moisture resistance properties.

However, the various and beneficial advantages and effects of the present disclosure are not limited to the foregoing, and will be more easily understood in the process of describing specific embodiments of the present disclosure.

### BRIEF DESCRIPTION OF THE DRAWINGS

FIG. 1 is a perspective view schematically showing an all-solid-state battery according to an embodiment.

FIG. 2 is a cross-sectional view of an all-solid-state battery according to an embodiment.

FIG. 3 is a cross-sectional SEM image of a margin layer included in an all-solid-state battery according to an embodiment.

FIG. 4 is an image of mapping Si elements in a unit area (20 mm*20 mm) of the margin layer.

FIG. 5 is a photograph of a cross section of a cell manufactured in Comparative Example 1 observed with an optical microscope.

FIG. 6 is a photograph of a cross section of a cell manufactured in Example 4 observed with an optical microscope.

FIG. 7 shows a graph of the charge/discharge capacity of the cell manufactured in Comparative Example 1 during 5 cycles under high temperature and high humidity conditions.

FIG. 8 shows a graph of the charge/discharge capacity of the cell manufactured in Example 4 during 5 cycles under high temperature and high humidity conditions.

### DETAILED DESCRIPTION OF THE EMBODIMENTS

Hereinafter, with reference to the accompanying drawings, the present disclosure will be described in detail so as to facilitate practice by those having ordinary knowledge in the art to which the present disclosure belongs. In order to clearly illustrate the present disclosure in the drawings, parts not pertinent to the description have been omitted, and identical or similar components are designated by the same reference numerals throughout the specification. Furthermore, the accompanying drawings are intended only to facilitate an understanding of the embodiments disclosed herein, and it is to be understood that the technical ideas disclosed herein are not limited by the accompanying drawings and include all modifications, equivalents, or substitutions that are within the scope of the ideas and technology of the present disclosure. In addition, some components are exaggerated, omitted, or schematically depicted in the accompanying drawings, and the dimensions of each component are not necessarily indicative of actual dimensions.

Throughout the present specification, unless explicitly described to the contrary, “comprising” any components will be understood to imply the inclusion of other components rather than the exclusion of any other components.

Throughout the specification, the “stacking direction” refers to a direction in which the components are stacked sequentially, and may also be a “thickness direction” perpendicular to a wide side (main plane) of the components on the sheet, which corresponds to a T-axis direction in the drawings. In addition, the “lateral direction” refers to a direction that extends from the edge of the component on the sheet, parallel to a wide surface (main surface), which may be a “plane direction” and corresponds to an L-axis direction in the drawings. In addition, a W-axis direction in the drawing may be a “width direction.”

Hereinafter, various embodiments and modifications will be described in detail with reference to the drawings.

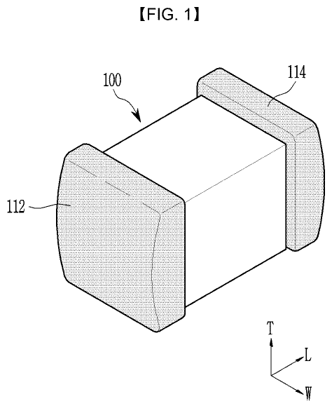

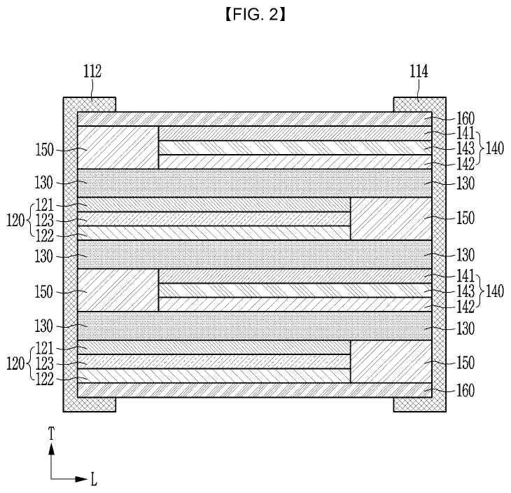

FIG. 1 is a perspective view schematically showing an all-solid-state battery according to an embodiment. FIG. 2 is a cross-sectional view of an all-solid-state battery according to an embodiment.

According to some embodiments, the all-solid-state battery 100 may have a roughly hexahedral shape.

In the present embodiment, for convenience of explanation, in the all-solid-state battery 100, both surfaces opposing each other in a thickness direction (T-axis direction) will be defined as a first surface and a second surface, and both surfaces connected to the first surface and the second surface and opposing each other in a length direction (L-axis direction) will be defined as a third surface and a fourth surface. According to some embodiments, the first side surface and second side surface opposing each other of the all-solid-state battery 100 may be the third surface and the fourth surface.

The all-solid-state battery 100 according to an embodiment includes a cell laminate including: electrode layers 120 and 140 and a solid electrolyte layer 130 disposed adjacent to the electrode layers 120 and 140 in a stacking direction, and a margin layer 150 disposed at edges of the electrode layers 120 and 140 in a lateral direction.

### Margin Layer

Referring to FIG. 2, a margin layer 150 is disposed along the edges of the positive electrode layer 120 and the negative electrode layer 140.

Referring to FIG. 2, the margin layer 150 may be located on the solid electrolyte layer 130 and may be disposed at edges of the positive electrode active material layers 121 and 122 or the negative electrode active material layers 141 and 142 in a lateral direction. Accordingly, the margin layer 150 may be located in the same layer of the positive electrode layer 120 and the negative electrode layer 140, respectively.

The margin layer 150 includes aluminosilicate particles (Al₂SiO₅); and ceramic glass that does not contain lithium.

The aluminosilicate particles are included in an amount of 10 vol % to 70 vol % based on the entire volume of the margin layer 150.

By including the aluminosilicate particles in the margin layer in a specific volume range, a strength of the margin layer may be increased, thereby effectively preventing the electrodes from being bent even when pressed. The margin layer 150 may also have excellent insulation and moisture resistance properties.

According to some embodiments, the aluminosilicate particles may be included in an amount of 10 vol % to 70 vol %, for example, 20 vol % to 70 vol %, 20 vol % to 60 vol %, or 30 vol % to 60 vol % based on the entire volume of the margin layer 150. If the above volume range is satisfied, the reliability of the battery may be improved by effectively preventing the electrodes from being bent while maintaining insulation and moisture resistance properties.

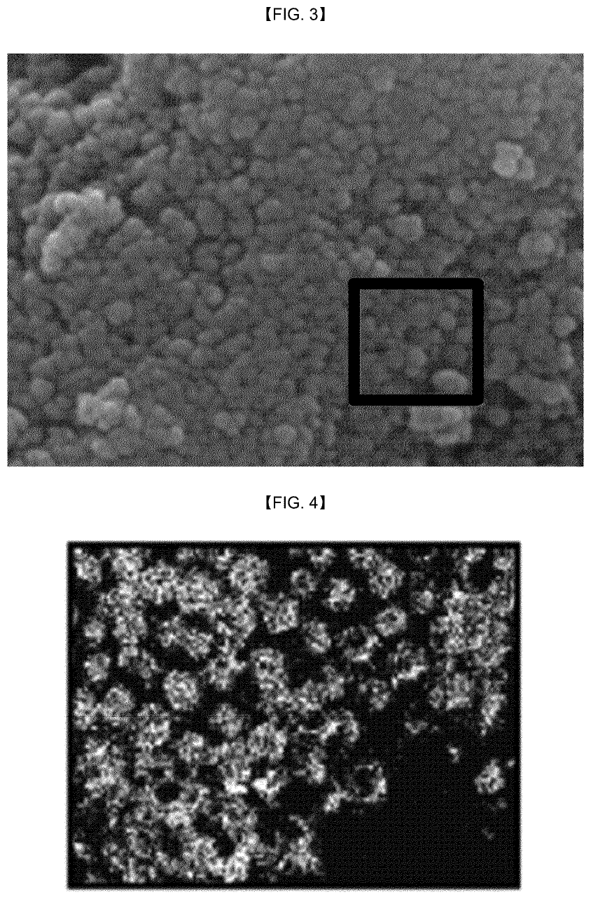

FIG. 3 is a cross-sectional SEM image of a margin layer included in an all-solid-state battery according to some embodiments, wherein the boxed area indicates a unit area (20 mm*20 mm). In addition, FIG. 4 is an image of mapping Si elements in a unit area (20 mm*20 mm) of the margin layer.

With reference to FIGS. 3 and 4, a method of measuring the volume % of aluminosilicate particles based on the entire margin layer 150 is as follows.

First, the all-solid-state battery according to an embodiment is processed by a method such as molding (DPA) to prepare a cross-sectional sample cut in the L-axis direction and the T-axis direction at a center of the W-axis direction of the all-solid-state battery. Then, a cross-sectional scanning electron microscope (SEM) photograph of the cross-sectional sample is taken.

The portion of the above scanning electron microscope (SEM) cross-sectional sample corresponding to the margin layer is subjected to component analysis using an energy dispersive X-ray spectrometer (EDS) installed on the SEM to determine the spectra of the aluminosilicate particles contained in the margin layer.

Next, mapping is performed on the Si elements in the SEM cross-sectional sample, and the area % of the aluminosilicate particle area at a position corresponding to a unit area of 20 mm*20 mm is measured in the mapping image. Referring to FIG. 4, the relatively bright portion may correspond to the area occupied by the aluminosilicate particles within a unit area.

From the mapping image, 10 points having the unit area may be randomly selected, the area % of the aluminosilicate particle area at each point may be measured to indicate the range of the area %, or the arithmetic mean of these measurements may be calculated to obtain the average area (%) of the aluminosilicate particles. Next, the area % of the obtained aluminosilicate particle area may be converted into volume % to obtain the volume % of aluminosilicate particles for the entire volume of the margin layer 150.

The aluminosilicate particles may have an average particle size of 1 μm to 5 μm, for example, 1 μm to 3 μm, 1.5 μm to 3 μm, or 1.5 μm to 2.5 μm. When the average particle size of the aluminosilicate particles satisfies the above range, the particles may be uniformly dispersed to effectively improve insulation and moisture resistance properties.

Ceramic glass that does not contain lithium (Li), has low ionic conductivity and electronic conductivity, and thus prevents leakage of ions and electrons from an all-solid-state battery to prevent the capacity of the battery from being degraded.

For reference, the ceramic glass (or crystallized glass) refers to a crystallographic mixture of amorphous and crystalline materials, such as peaks and halos observed in X-ray diffraction, electron beam diffraction, etc. Therefore, the ceramic glass is a material in a state in which amorphous and crystalline materials are mixed because crystallization is partially carried out through sintering.

The ceramic glass that does not contain lithium, may contain at least one selected from the group consisting of silicon (Si) oxide, boron (B) oxide, sodium (Na) oxide, barium (Ba) oxide, zinc (Zn) oxide, aluminum (Al) oxide, and combinations thereof.

The ceramic glass that does not contain lithium, may contain at least one selected from the group consisting of SiO₂, B₂O₃, Na₂O, BaO₅, ZnO, Al₂O₃, and combinations thereof. According to some embodiments, Al₂O₃—SiO₂ may be used as the ceramic glass that does not contain lithium.

The ceramic glass that does not contain lithium may have a glass transition temperature (T_{g}) of 440° C. to 480° C. If the glass transition temperature (T_{g}) of the ceramic glass that does not contain lithium satisfies the above range, since it has a glass transition temperature (T_{g}) similar to a sintering temperature of the solid electrolyte, deformation due to heat may be prevented during the sintering process, thereby effectively preventing the electrodes from being bent.

The ceramic glass that does not contain lithium may be included in an amount of 10 vol % to 70 vol %, for example, 20 vol % to 70 vol %, 20 vol % to 60 vol %, or 30 vol % to 60 vol % based on the entire volume of the margin layer 150. If the above volume range is satisfied, an all-solid-state battery having excellent insulation and moisture resistance properties may be implemented.

A volume ratio of the aluminosilicate particles to the ceramic glass that does not contain lithium in margin layer 150 may be 10:90 to 90:10, for example, 20:80 to 80:20, 30:70 to 70:30, 40:60 to 60:40, or 45:55 to 55:45.

If the above volume ratio is satisfied, the reliability of the battery may be improved by effectively preventing the electrodes from being bent while maintaining insulation and moisture resistance properties.

The margin layer 150 may further include an insulating material having an ionic conductivity of 1.0×10⁻¹⁰ S/cm or less or 1.0×10⁻⁶ S/cm or less, and may be of any type, as long as it is commonly used.

For example, the insulating material may include an insulating material such as ceramic or resin.

The ceramic may contain at least one selected from the group consisting of aluminum nitride (AlN), beryllium oxide (BeO), boron nitride (BN), silicon (Si), silicon carbide (SiC), silicon nitride (Si₃N₄), gallium arsenide (GaAs), gallium nitride (GaN), barium titanate (BaTiO₃), a mixture thereof, and oxides and/or nitrides of these materials.

For example, the resin may include polyolefin such as polyethylene or polypropylene, polyester such as polyethylene terephthalate (PET), polyurethane, or polyimide.

In addition, the margin layer 150 may further include a solid electrolyte included in the solid electrolyte layer 130, which will be described later, and may include one or more solid electrolytes, but is not limited thereto.

### Cover Layer

A cover layer 160 may be further located on one surface or both surfaces of the cell laminate of the all-solid-state battery 100 in a stacking direction. According to some embodiments, the cover layer 160 may be located on the outermost side in a stacking direction of the cell laminate of the all-solid-state battery 100. By being located on the outside of the cell laminate, the cover layer 160 may serve to cushion the impact of the all-solid-state battery, prevent moisture from entering the cell, and prevent leakage of current.

According to some embodiments, the cover layers 160 may surround surfaces of the cell laminate so that one end of the positive electrode layer 120 is exposed to the first surface and connected to the external electrode 112 on one side and one end of the negative electrode layer 140 is exposed to the second surface and connected to the external electrode 114 on the other side. For example, the cover layers 160 may be located on the third surface and the fourth surface of the cell laminate excluding the first surface and the second surface of the cell laminate or may be disposed on outer surfaces of the positive electrode layer 120 located at the lowermost end in a stacking direction of the cell laminate and the negative electrode layer 140 located at the uppermost end in the stacking direction of the cell laminate. Here, a solid electrolyte layer 130 may be disposed between the cover layer 160 and the positive electrode layer 120 or negative electrode layer 140 adjacent thereto.

According to some embodiments, the cover layer 160 may have the same composition as the margin layer 150 to provide insulation and moisture resistance properties and improve strength. In addition to the margin layer 150, the cover layer 160 may also have the same composition as the margin layer to more effectively prevent the electrodes from being bent.

According to some embodiments, the cover layer 160 may include aluminosilicate particles (Al₂SiO₅); and ceramic glass that does not contain lithium.

According to some embodiments, the aluminosilicate particles may be included in an amount of 10 vol % to 70 vol %, for example, 20 vol % to 70 vol %, 20 vol % to 60 vol %, or 30 vol % to 60 vol % based on the entire volume of the cover layer 160. If the above volume range is satisfied, the reliability of the battery may be improved by effectively preventing electrodes from being bent while maintaining insulation and moisture resistance properties.

The ceramic glass that does not contain lithium, may contain at least one selected from the group consisting of silicon (Si) oxide, boron (B) oxide, sodium (Na) oxide, barium (Ba) oxide, zinc (Zn) oxide, aluminum (Al) oxide, or combinations thereof.

The ceramic glass that does not contain lithium, may contain at least one selected from the group consisting of SiO₂, B₂O₃, Na₂O, BaO₅, ZnO, Al₂O₃, or combinations thereof.

The ceramic glass that does not contain lithium may be included in an amount of 10 vol % to 70 vol %, for example, 20 vol % to 70 vol %, 20 vol % to 60 vol %, or 30 vol % to 60 vol % based on the entire volume of the cover layer 160. If the above volume range is satisfied, an all-solid-state battery having excellent insulation and moisture resistance properties may be implemented.

A volume ratio of the aluminosilicate particles and the ceramic glass that does not contain lithium may be 30:70 to 70:30, for example, 40:60 to 60:40, or 45:55 to 55:45 based on the entire cover layer 160.

If the above volume ratio is satisfied, the reliability of the battery may be improved by effectively preventing the electrodes from being bent while maintaining insulation and moisture resistance properties.

The cover layer 160 may further include an insulating material having an ionic conductivity of 1.0×10⁻¹⁰ S/cm or less or 1.0×10⁻⁶ S/cm or less to provide insulation properties, and may be of any type, as long as it is commonly used.

For example, the insulating material may include an insulating material such as ceramic or resin, which is the same as the insulating material included in the margin layer, and thus detailed description will be omitted.

As described above, the all-solid-state battery 100 according to some embodiments includes a margin layer including aluminosilicate particles and ceramic glass that does not contain lithium to effectively prevent the electrodes from being bent, so that an electrode bending ratio may be 0.95 to 1.05. If the electrode bending ratio satisfies the above value, almost no bending of the electrode occurs, and short circuit of the battery may be effectively prevented, thereby improving the reliability of the battery.

The electrode bending ratio is a ratio of a length of the electrode layer in the T-axis direction on both sides of the all-solid-state battery to which the margin layers are applied to a length of the electrode layer in the T-axis direction at the center of the all-solid-state battery where the margin layer does not exist, and may be a parameter indicating a degree of bending of the electrode.

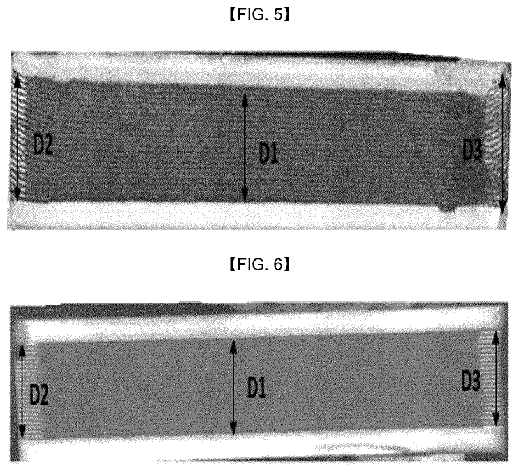

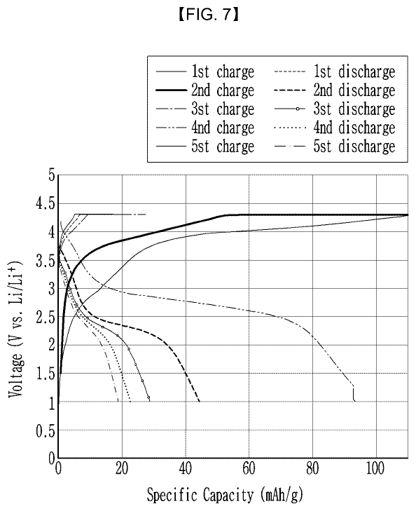

FIGS. 5 and 6 are images observed through an optical microscope of a cross-section (hereinafter referred to as an LT cross-section) cut in the L- and T-axis directions perpendicular to the W-axis direction at the center (½ point) of the W-axis direction of an all-solid-state battery. A relatively dark part in the image may correspond to the electrode layer.

Referring to FIGS. 5 and 6, a length of both ends of the electrode layer may be measured in the T-axis direction at the center (½ point) of the L-axis direction in the LT cross-section of the all-solid-state battery, and may be D1. D1 may be a length of the electrode layer measured at the center of the all-solid-state battery to which the margin layer is not applied, and may be an arithmetic average of lengths measured at five points spaced apart from a reference point by a predetermined interval with the center point as the reference point.

In addition, lengths of both ends of the electrode layer may be measured in the T-axis direction on both sides of the LT cross-section of the all-solid-state battery, and may be D2 and D3. D2 and D3 may be lengths of the electrode layer measured on both sides of the all-solid-state battery to which the margin layers are applied, and may be arithmetic averages of lengths measured at five points on both sides of the all-solid-state battery to which the margin layers are not applied.

Here, all of the measurement points should be located within the cell laminate of the all-solid-state battery, and the location of the reference points may be changed or the spacing between points may be adjusted if necessary.

Next, the values of A1 and A2 may be calculated through Equations 1 and 2 below, and the average values of A1 and A2 may be used as the “electrode bending ratio.”

$$A 1 = D 2 / D 1 \qquad [ Equation 1 ]$$

$$A 2 = D 3 / D 1 \qquad [ Equation 2 ]$$

### Solid Electrolyte Layer

The solid electrolyte layer 130 may be interposed and stacked between the positive electrode layer 120 and the negative electrode layer 140. Accordingly, the solid electrolyte layer 130 may be disposed adjacent to positive electrode active material layers 121 and 122 of the positive electrode layer 120 and negative electrode active material layers 141 and 142 of the negative electrode layer 140 in a stacking direction.

Thus, in the all-solid-state battery 100, a plurality of positive electrode layers 120 and negative electrode layer 140 may be alternately disposed and a plurality of solid electrolyte layers 130 may be interposed therebetween and stacked. The all-solid-state battery 100 may be a multilayer all-solid-state battery 100 manufactured by alternately stacking a plurality of positive electrode layers 120 and negative electrode layers 140, manufacturing a cell laminate by interposing a plurality of solid electrolyte layers 130 therebetween, and then sintering it at a time.

The solid electrolyte layer 130 may include an inorganic solid electrolyte including an oxide-based solid electrolyte, a sulfide-based solid electrolyte, or a combination thereof.

Oxide-based solid electrolytes may be Garnet-type, Nasicon-type, LISICON-type, perovskite-type, LiPON-type, or amorphous (glass) electrolytes.

Garnet-type solid electrolytes may refer to lithium lanthanum zirconium oxide (LLZO), represented by LiₐLa_{b}Zr_{c}O₁₂ (0<a<7, 0<b<3, 0<c<2), such as Li₇La₃Zr₂O₁₂, and Nasicon-type solid electrolytes may refers to lithium-aluminum-titanium-phosphate (LATP) of Li₁₊ₓAlₓTi₂₋ₓ(PO₄)₃ (0<x<1) where Ti is introduced into a compound of the type Li₁₊ₓAlₓM₂₋ₓ(PO₄)₃ (LAMP) (where 0<x<2, and M is Zr, Ti, or Ge), lithium-aluminum-germanium-phosphate (LAGP), represented by Li₁₊ₓAlₓGe₂₋ₓ(PO₄)₃ (0<x<1), such as Li_{1.3}Al_{0.3}Ti_{1.7}(PO₄)₃ and/or lithium-zirconium-phosphate (LZP) as LiZr₂(PO₄)₃ with an excess of lithium introduced.

In addition, the LISICON-type solid electrolytes may be represented by xLi₃AO₄-(1-x)Li₄BO₄ (where A is P, As, or V, etc., and B is Si, Ge, or Ti, etc., and 0<x<1), which may refer to solid solution oxides including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, etc., or may be represented by Li₄₋ₓM_{1-y}M′_{y}S₄ (where M is Si or Ge, and M′ is P, Al, Zn, or Ga, and 0<y<1), which may refer to solid solution sulfides including Li₂S—P₂S₅, Li₂S—SiS₂, Li₂S—SiS₂—P₂S₅, or Li₂S—GeS₂, etc.

The perovskite-type solid electrolyte may refer to lithium-lanthanum titanate (LLTO), represented by Li₃ₓLa_{2/3-x}□_{1/3-2x}TiO₃ (0<x<0.16, □: vacancy), such as Li_{1/8}La_{5/8}TiO³, etc. The LiPON-type solid electrolyte may refer to a nitride, such as lithium-phosphorous oxynitride, such as Li_{2.8}PO_{3.3}N_{0.46}.

The amorphous electrolyte may include, for example, Li₂O—B₂O₃—SiO₂, Li₂O—B₂O₃—P₂O₅, Li₃BO₃—Li₂CO₃, or Li₃BO₃—Li₂CO₃.

The sulfide-based solid electrolyte contains sulfur atoms as the electrolyte components, and is not particularly limited to specific components, and may include one or more of a crystalline solid electrolyte, an amorphous solid electrolyte (glassy solid electrolyte), or a glass ceramic solid electrolyte.

For example, sulfide-based solid electrolytes may be a Thio-LISICON-type compound such as LPS-type sulfides containing sulfur and phosphorus (e.g., Li₂S—P₂S₅), Li₄₋ₓGe₁₋ₓPₓS₄ (where x may be 0.1 to 2, or x may be ¾ or ⅔), Li_{10±1}MP₂X₁₂ (where M is Ge, Si, Sn, or Al, X is S or Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (where x is 70 to 80), Li₂S—SiS₂—Li₃N, Li₂S—P₂S₅—LiI, Li₂S—SiS₂—LiI, Li₂S—B₂S₃—LiI, Li₁₀SnP₂S₁₂, Li_{3.25}Ge_{0.25}P_{0.75}S₄.

The solid electrolyte may have an ionic conductivity of 1×10⁻³ S/cm or more. Ion conductivity may be a value measured at a temperature of 25° C. The ionic conductivity may be 1.0×10⁻³ S/cm or more, 2.0×10⁻³ S/cm or more, 3.0×10⁻³ S/cm or more, 4.0×10⁻³ S/cm or more, or 5.0×10⁻³ S/cm or more, with the upper limit not being particularly limiting. When a solid electrolyte satisfying the ionic conductivity of the range is used, the all-solid-state battery 100 may exhibit high output.

### Electrode Layer

The electrode layers 120 and 140 may include a positive electrode layer 120 and a negative electrode layer 140, and may essentially include current collectors 123 and 143 and active material layers 121, 122, 141, and 142 applied to at least one surface of the current collectors 123 and 143.

The positive electrode layer 120 may be formed by applying the positive electrode active material layers 121 and 122 to at least one surface of the positive electrode current collector 123, and the negative electrode layer 140 may be formed by applying the negative electrode active material layers 141 and 142 to at least one surface of the negative electrode current collector 143.

For example, the electrode layer located at the bottom relative to the stacking direction may be formed by applying the positive electrode active material layer 122 on one surface of the positive electrode current collector 123, and the electrode layer located at the uppermost end may be formed by applying the negative electrode active material layer 141 on one surface of the negative electrode current collector 143.

Also, the electrode layers located between the uppermost end and the lowermost end may be formed by applying the positive electrode active material layers 121 and 122 to both surface of the positive electrode current collector 123, or by applying the negative electrode active material layers 141 and 142 to both surface of the negative electrode current collector 143.

The positive electrode active material layers 121 and 122 may include a positive electrode active material and, optionally, a solid electrolyte. Additionally, the positive electrode active material layers 121 and 122 may optionally further include additives such as a binder or a conductive agent.

According to some embodiments, the positive electrode active material is not particularly limited as long as it can secure sufficient capacity of the all-solid-state battery 100. For example, the positive electrode active material may include lithium cobalt oxide, lithium nickel cobalt manganese oxide, lithium nickel cobalt aluminum oxide, lithium iron phosphorus oxide, lithium manganese oxide, or a combination thereof.

For example, the positive electrode active material may be a compound represented by the following formulas: LiₐA_{1-b}M_{b}D₂ (where 0.90≤a≤1.8, 0≤b≤0.5); LiₐE_{1-b}MbO_{2-c}D_{c} (where 0.90≤a≤1.8, 0≤b≤0.5, 0≤c≤0.05); LiE_{2-b}MbO_{4-c}D_{c} (where 0≤b≤0.5, 0≤c≤0.05); LiₐNi_{1-b-c}Co_{b}M_{c}D_{α} (where 0.90≤a≤1.8, 0≤b≤0.5, 0≤c≤0.05, 0≤α≤2); LiₐNi_{1-b-c}CO_{b}M_{c}O_{2-α}X_{α} (where 0.90≤a≤1.8, 0≤b≤0.5, 0≤c≤0.05, 0<α<2); LiₐNi_{1-b-c}Co_{b}M_{c}O_{2-α}X₂ (where 0.90≤a≤1.8, 0≤b≤0.5, 0≤c≤0.05, 0<α<2); LiₐNi_{1-b-c}Mn_{b}M_{c}D_{α} (where 0.90≤α≤1.8, 0≤b≤0.5, 0≤c≤0.05, 0<α≤2); LiₐNi_{1-b-c}Mn_{b}M_{c}O_{2-α}X_{α} (where 0.90≤a≤1.8, 0≤b≤0.5, 0≤c≤0.05, 0<α<2); LiₐNi_{1-b-c}Mn_{b}M_{c}O_{2-α}X₂ (where 0.90≤a≤1.8, 0≤b≤0.5, 0≤c≤0.05, 0<α<2); LiₐN_{b}E_{c}G_{b}O₂ (where 0.90≤a≤1.8, 0≤b≤0.9, 0≤c≤0.5, 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, 0.001≤e≤0.1); LiₐNiGbO₂ (where 0.90≤a≤1.8, 0.001≤b≤0.1); LiₐCoGbO₂ (where 0.90≤a≤1.8, 0.001≤b≤0.1); LiₐMnGbO₂ (where 0.90≤a≤1.8, 0.001≤b≤0.1); LiₐMn₂GbO₄ (where 0.90≤a≤1.8, 0.001≤b≤0.1); QO₂; QS₂; LiQS₂; V₂O₅; LiV₂O₂; LiRO₂; LiNIVO₄; Li_{(3-f)}J₂(PO₄)₃ (0≤f≤2); Li_{(3-f)}Fe₂(PO₄)₃ (where 0≤f≤2); and LiFePO₄, wherein A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and Jis V, Cr, Mn, Co, Ni, or Cu.

The positive electrode active material may also be LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5, 0≤y≤0.5), LiFePO₄, TiS₂, FeS₂, TiS₃, or FeS₃.

The solid electrolyte may be any solid electrolyte available in the solid electrolyte layer 130 described above. The solid electrolyte may function as an ionic conduction channel within the positive electrode layer 120, thereby reducing the interface resistance.

The content of the solid electrolyte may be 0.1 parts by weight or more, 1 part by weight or more, or 10 parts by weight or more, and 80 parts by weight or less, 60 parts by weight, or 50 parts by weight or less, based on a total of 100 parts by weight of the positive electrode active material.

The conductive agent is not particularly limited as long as it has conductivity without causing chemical changes in the all-solid-state battery 100. For example, conductive agent may include graphite, such as natural or artificial graphite; carbon-based materials, such as carbon black, acetylene black, Ketjen Black®, channel black, furnace black, lamp black, and summer black; conductive fibers, such as carbon fiber or metal fiber; carbon fluoride; metal powders, such as aluminum and nickel powder; conductive whiskers, such as zinc oxide and potassium titanate; conductive metal oxides, such as titanium oxide; and conductive materials, such as polyphenylene derivatives.

The content of the conductive agent may be 1 part by weight to 10 parts by weight, for example, 2 parts by weight to 5 parts by weight, based on the total of 100 parts by weight of the positive electrode active material. If the content of the conductive agent is within the above range, the finally obtained electrode may have excellent conductivity properties.

A binder may be used to improve bonding strength between an active material and a conductive agent. The binders may include, for example, at least one selected from the group consisting of polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diether polymer (EPDM), sulfonated EPDM, styrene butadiene rubber, fluorinated rubber, and various copolymers.

The content of the binder may be 1 part by weight to 50 parts by weight, for example, 2 parts by weight to 5 parts by weight, based on 100 parts by weight of the positive electrode active material. If the content of the binder satisfies the above range, the active material layer may have high bonding strength.

The positive electrode current collector 123 may be porous, such as a network or mesh-like, and may be a porous metal plate, such as stainless steel, nickel, aluminum, etc. In addition, the positive electrode current collector 123 may be coated with an oxidation-resistant metal or alloy film to prevent oxidation.

The negative electrode active material layers 141 and 142 may include a negative electrode active material and, optionally, a solid electrolyte. Additionally, the negative electrode active material layers 141 and 142 may optionally further include additives such as a binder or a conductive agent.

The negative electrode active material may be carbon-based material, silicon, silicon oxide, silicon-based alloy, silicon-carbon-based material composite, tin, tin-based alloy, tin-carbon composite, metal oxide, or a combination thereof, and may include lithium metal and/or lithium metal alloy.

The lithium metal alloy may include lithium and metals/metalloids capable of alloying with lithium. For example, metals/metalloids capable of alloying with lithium may include Si, Sn, Al, Ge, Pb, Bi, Sb, Si—Y alloys (where Y is an alkali metal, an alkaline earth metal, an element in groups 13 to 16, a transition metal, rare earth elements or a combination of these elements, but do not include Si), Sn—Y alloy (where Y is an alkali metal, an alkaline earth metal, an element in groups 13 to 16, a transition metal, a transition metal oxide such as lithium titanium oxide (Li₄Ti₅O₁₂), a rare earth element, or a combination of these elements, but does not include Sn), or MₙOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

In addition, oxides of metals/metalloids capable of alloying with lithium may be lithium titanium oxide, vanadium oxide, lithium vanadium oxide, SnO₂, SiOₓ (0<x<2), etc. For example, the negative electrode active material may include one or more elements selected from the group consisting of elements in groups 13 to 16 of the periodic table of elements. For example, the negative electrode active material may include one or more elements selected from the group consisting of Si, Ge, and Sn.

The carbon-based material may be crystalline carbon, amorphous carbon, or a mixture thereof. Crystalline carbon may be graphite, such as natural graphite or artificial graphite, in the form of amorphous, platelets, flakes, spheres, or fibers. In addition, amorphous carbon may be soft carbon (low-temperature calcined carbon) or hard carbon, mesophase pitch carbide, calcined coke, graphene, carbon black, fullerene soot, carbon nanotube, and carbon fiber.

Silicon may be Si, SiOₓ (0<x<2, for example 0.5 to 1.5), Sn, SnO₂, or silicon-containing metal alloy and a mixture thereof. The silicon-containing metal alloy may include, for example, silicon and one or more of Al, Sn, Ag, Fe, Bi, Mg, Zn, in, Ge, Pb, and Ti.

The solid electrolyte may be any solid electrolyte available in the solid electrolyte layer 130 described above. The solid electrolyte may function as an ionic conduction channel within the negative electrode layer 140, thereby reducing the interface resistance.

The content of the solid electrolyte may be 0.1 parts by weight or more, 1 part by weight or more, or 10 parts by weight or more, and may be 80 parts by weight or less, 60 parts by weight or less, or 50 parts by weight or less, based on the total of 100 parts by weight of the negative electrode active material.

The negative electrode active material layers 141 and 142 may also optionally include a conductive agent and a binder as described for the positive electrode active material layers 121 and 122.

The negative electrode current collector 143 may be porous, such as a network or mesh-like, and may be a porous metal plate, such as stainless steel, nickel, aluminum, etc. In addition, the negative electrode current collector 143 may be coated with an oxidation-resistant metal or alloy film to prevent oxidation.

### External Electrode

The terminal of the positive electrode current collector 123 and the terminal of the negative electrode current collector 143 are exposed on both sides of the cell laminate of the all-solid-state battery 100, and external electrodes 112 and 114 may be connected and coupled to the exposed terminals. That is, the external electrodes 112 and 114 may be configured to be connected to the terminal of the positive electrode current collector 123 to have a positive electrode, and to be connected to the terminal of the negative electrode current collector 143 to have a negative electrode. If the terminals of the positive electrode current collector 123 and the terminals of the negative electrode current collector 143 are configured to face opposite directions from each other, the external electrodes 112 and 114 may also be located on each side.

The external electrodes 112 and 114 may cover not only the cell laminate but also the lateral direction of the outer layer. That is, as the cover layer is manufactured by sintering at a time when manufacturing the cell laminate, and the external electrodes 112 and 114 are subsequently formed, the external electrodes 112 and 114 may also be located in a lateral direction of the cover layer.

The external electrodes 112 and 114 may include conductive metal and glass.

The conductive metal may include, for example, at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof.

The glass component included in the external electrodes 112 and 114 may be a composition in which oxides are mixed. The glass component may include, for example, silicon oxide, boron oxide, aluminum oxide, transition metal oxide, alkali metal oxide, alkaline earth metal oxide, or a combination thereof. Here, the transition metal may be selected from the group consisting of zinc (Zn), titanium (Ti), copper (Cu), vanadium (V), manganese (Mn), iron (Fe), and nickel (Ni), and the alkali metal may be selected from the group consisting of lithium (Li), sodium (Na), and potassium (K), and the alkaline earth metal may be selected from the group consisting of magnesium (Mg), calcium (Ca), strontium (Sr), and barium (Ba).

A method of forming the external electrodes 112 and 114 is not particularly limited. For example, the external electrodes 112 and 114 may be formed by dipping the cell laminate in a conductive paste containing conductive metal and glass, or by printing the conductive paste on the surface of the cell laminate, such as by screen printing or gravure printing. In addition, various methods, such as by applying a conductive paste to the surface of the cell laminate, or by transferring a dried film of the conductive paste to the surface of the cell laminate may be used.

A multilayer all-solid-state battery according to some embodiments includes: a cell laminate including a plurality of solid electrolyte layers; a plurality of positive electrode layers and negative electrode layers alternately disposed with each of the plurality of solid electrolyte layers interposed therebetween; and margin layers disposed at edges of the positive electrode layers and the negative electrode layers in a lateral direction, wherein the margin layers include aluminosilicate particles (Al₂SiO₅); and ceramic glass that does not contain lithium, and the aluminosilicate particles are included in an amount of 10 vol % to 70 vol % based on the entire volume of the margin layers.

According to some embodiments, the multilayer all-solid-state battery may further include a cover layer located on one or both surfaces in a stacking direction of the cell laminate. The cover layer may include aluminosilicate particles (Al₂SiO₅); and ceramic glass that does not contain lithium.

According to some embodiments, the multilayer all-state battery may include first and second external electrodes disposed adjacent to the cell laminate or the cover layer in a lateral direction and respectively connected to the plurality of positive electrode layers and the plurality of negative electrode layers.

Specific examples of the present disclosure are described below. However, the examples described below are intended only to illustrate or described the present disclosure in detail, and should not be construed as limiting the scope of the present disclosure.

### EXAMPLES

### Comparative Example 1

LiCoO₂ (LCO) as a positive electrode active material and Li₂O—B₂O₃—SiO₂ (hereinafter referred to as LBSO) as a solid electrolyte was mixed in a volume ratio of 5:5, and a positive electrode layer with a thickness of 30 μm was manufactured using a screen printer. 2 μm graphite as a negative electrode active material and LBSO as a solid electrolyte were mixed in a volume ratio of 5:5, and a negative electrode layer with a thickness of 30 μm was manufactured using a screen printer. LBSO as a solid electrolyte was molded to a thickness of 50 μm to manufacture a solid electrolyte layer. Using 100 vol % of LBSO, a margin layer was manufactured with a thickness of 30 μm.

An all-solid-state battery cell was manufactured by stacking and pressurizing the manufactured positive electrode layer, negative electrode layer, solid electrolyte layer, and margin layer.

### Comparative Example 2

A cell was manufactured in the same manner as in Comparative Example 1, except that the composition of the margin layer was 50 vol % of LBSO and 50 vol % of Al₂O₃.

### Comparative Example 3

A cell was manufactured in the same manner as in Comparative Example 1, except that the composition of the margin layer was 50 vol % of LBSO and 50 vol % of SiO₂.

### Comparative Example 4

A cell was manufactured in the same manner as in Comparative Example 1, except that the composition of the margin layer was 10 vol % of LBSO and 90 vol % of aluminosilicate particles.

### Comparative Example 5

A cell was manufactured in the same manner as in Comparative Example 1, except that the composition of the margin layer was 5 vol % of LBSO and 95 vol % of aluminosilicate particles.

### Comparative Example 6

A cell was manufactured in the same manner as in Comparative Example 1, except that the composition of the margin layer was 100 vol % of aluminosilicate particles.

### Example 1

A cell was manufactured in the same manner as in Comparative Example 1, except that the margin layer was manufactured by blending 10 vol % of aluminosilicate particles (2 μm) and 90 vol % of Al₂O₃—SiO₂ as ceramic glass that does not contain lithium.

### Example 2

A cell was manufactured in the same manner as in Example 1, except that the margin layer was manufactured by blending 20 vol % of aluminosilicate particles (2 μm) and 80 vol % of Al₂O₃—SiO₂ as ceramic glass that does not contain lithium.

### Example 3

A cell was manufactured in the same manner as in Example 1, except that the margin layer was manufactured by blending 30 vol % of aluminosilicate particles (2 μm) and 70 vol % of Al₂O₃—SiO₂ as ceramic glass that does not contain lithium.

### Example 4

A cell was manufactured in the same manner as in Example 1, except that the margin layer was manufactured by blending 50 vol % of aluminosilicate particles (2 μm) and 50 vol % of Al₂O₃—SiO₂ as ceramic glass that does not contain lithium.

### Example 5

A cell was manufactured in the same manner as in Example 1, except that the margin layer was manufactured by blending 60 vol % of aluminosilicate particles (2 μm) and 40 vol % of Al₂O₃—SiO₂ as ceramic glass that does not contain lithium.

### Example 6

A cell was manufactured in the same manner as in Example 1, except that the margin layer was manufactured by blending 70 vol % of aluminosilicate particles (2 μm) and 30 vol % of Al₂O₃—SiO₂ as ceramic glass that does not contain lithium.

### Evaluation Example

### 1. Electrode Bending Ratio Evaluation

A cross section (hereinafter, referred to as an LT cross section) cut in the L- and T-axis directions perpendicular to the W-axis direction at the center (½ point) of the W-axis direction of the cell manufactured above was observed at 25× magnification through an optical microscope.

FIGS. 5 and 6 show images observed through an optical microscope of the LT cross-section cut perpendicular to the W-axis direction at the center (½ point) of the W-axis direction of the cells manufactured in Comparative Example 1 and Example 4, respectively.

Referring to FIGS. 5 and 6, a length of both ends of the electrode layer may be measured in the T-axis direction at the center (½ point) of the L-axis direction in the LT cross-section of the cell, and may be D1. A length of both ends of the electrode layer may be measured in the T-axis direction on both sides of the LT cross-section of the cell, and may be D2 and D3.

Next, the values of A1 and A2 are calculated through Equations 1 and 2 below. The average values of A1 and A2 are used as the “electrode bending ratio.” and are shown in Table 1 below.

$$A 1 = D 2 / D 1 \qquad [ Equation 1 ]$$

$$A 2 = D 3 / D 1 \qquad [ Equation 2 ]$$

Referring to Table 1 below, it can be seen that the electrode bending ratio of the cells manufactured in Examples 1 to 6 satisfies the range of 0.95 to 1.05, while the electrode bending ratio of the cells manufactured in Comparative Examples 1 to 6 exceeds 1.05 or is less than 0.95, and thus the electrode is much more bent.

Also, referring to FIG. 5 (Comparative Example 1) and FIG. 6 (Example 4), it can be seen that the degree of bending of the electrodes is significantly different from the images.

### 2. Short-Circuit Occurrence Frequency Evaluation

The cells manufactured in Examples 1 to 6 and Comparative Examples 1 to 6 were charged and discharged for 5 cycles. If the number of short-circuit occurred was 5, it was written as ‘◯’, if the number of short circuits occurred 3 to 4, it was as ‘Δ’, and if the number of short-circuits occurred was 1 to 2, it was written as ‘X’. The results are shown in Table 1 below.

Referring to Table 1 below, it can be seen that significantly more short-circuits due to electrode bending occurred in the cells manufactured in Comparative Examples 1 to 6 compared to Examples 1 to 6.

### 3. Evaluation of Charge/Discharge Efficiency Under High Temperature and High Humidity Conditions

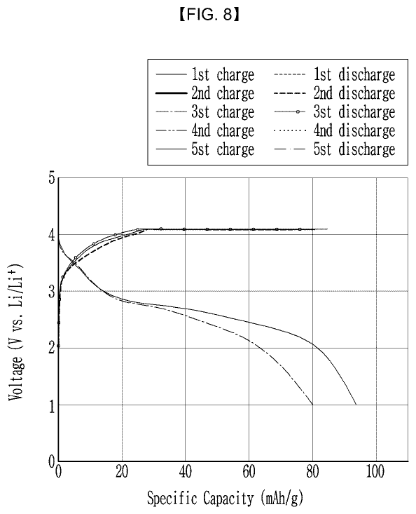

The cells manufactured in Examples 1 to 6 and Comparative Examples 1 to 6 were charged to a maximum voltage of 4.3V at a constant current of 0.5 C under conditions of 90% humidity and 60° C., and the charge/discharge cycle of discharging at 0.5 C until the final discharge voltage of 1.0V was repeated for 5 cycles. In addition, a ratio of the discharge capacity in the 5th cycle to the discharge capacity in the 1st cycle was calculated as the capacity maintenance rate (%), and the results are shown in Table 1 below. Additionally, graphs of charge/discharge capacity for 5 cycles of Comparative Example 1 and Example 4 are shown in FIGS. 7 and 8.

TABLE 1

| | Composition of | | Short | Capacity |
|---|---|---|---|---|
| | margin layer | Electrode | occurrence | maintenance |
| | (vol %) | bending ratio | frequency | rate(%) |
| Example 1 | Al₂SiO₅ 10% | 1.05 | Δ | 65-75% |
| | Al₂O₃—SiO₂ 90% | | | |
| Example 2 | Al₂SiO₅ 20% | 1.03 | Δ | 75-80% |
| | Al₂O₃—SiO₂ 80% | | | |
| Example 3 | Al₂SiO₅ 30% | 1.02 | X | 80-85% |
| | Al₂O₃—SiO₂ 70% | | | |
| Example 4 | Al₂SiO₅ 50% | 1 | X | 85% or more |
| | Al₂O₃—SiO₂ 50% | | | |
| Example 5 | Al₂SiO₅ 60% | 0.98 | X | 80-85% |
| | Al₂O₃—SiO₂ 40% | | | |
| Example 6 | Al₂SiO₅ 70% | 0.96 | Δ | 65-80% |
| | Al₂O₃—SiO₂ 30% | | | |
| Comp. Example 1 | LBSO 100% | 1.2-1.3 | ◯ | 50% or less |
| Comp. Example 2 | LBSO 50% | 1.2 | ◯ | 50-55% |
| | Al₂O₃ 50% | | | |
| Comp. Example 3 | LBSO 50% | 1.10 | ◯ | 60-65% |
| | SiO₂ 50% | | | |
| Comp. Example 4 | LBSO 10% | 0.8 | Δ | 56-60% |
| | Al₂SiO₅ 90% | | | |
| Comp. Example 5 | LBSO 5% | 0.75 | ◯ | 51-55% |
| | Al₂SiO₅ 95% | | | |
| Comp. Example 6 | Al₂SiO₅ 100% | 0.7 | ◯ | 50% or less |

Referring to Table 1, it can be seen that for the cells manufactured in Examples 1 through 6, the capacity after 5 cycles may be maintained at 65% or more of the initial capacity, for example, 85% or more in Example 4, indicating that the cycle characteristics of the batteries were very excellent.

On the other hand, it can be seen that for the cells manufactured in Comparative Examples 1 to 6, the capacity after 5 cycles was 65% or less of the initial capacity, indicating that the cycle characteristics of the batteries were very poor.

Also, referring to FIGS. 7 and 8, it can be seen that when charging and discharging for 5 cycles under a high temperature and high humidity environment, the capacity of the cell manufactured in Example 4 was maintained high, while the capacity of the cell manufactured in Comparative Example 1 was very poor.

It is to be understood that although the preferred embodiment of the present disclosure has been described above, the present disclosure is not limited thereto, but can be implemented in various modifications within the scope of the claims, the detailed description of the present disclosure, and the accompanying drawings, which also fall within the scope of the present disclosure.

### DESCRIPTION OF SYMBOLS

100: All-solid-state battery
112, 114: External electrode
120: Positive electrode layer
121, 122: Positive electrode active material layer
123: Positive electrode current collector
130: Solid electrolyte layer
140: Negative electrode layer
141, 142: Negative electrode active material layer
143: Negative electrode current collector
150, 151, 152, 153, 154: Margin layer
160: Cover layer

### INDUSTRIAL APPLICABILITY

The present disclosure relates to an all-solid-state battery, which has the advantage of preventing bending of the electrode while maintaining insulation and moisture resistance properties, thus making it applicable to various electrochemical devices and electronic devices.

What is claimed is:

1. An all-solid-state battery comprising:
a cell laminate including a solid electrolyte layer; a positive electrode layer and a negative electrode layer disposed with the solid electrolyte layer interposed therebetween; and a margin layer disposed at at least one of edges of the positive electrode layer and the negative electrode layer in a lateral direction,
wherein the margin layer includes aluminosilicate particles (Al₂SiO₅), and ceramic glass that does not contain lithium, and
the aluminosilicate particles are included in an amount of 10 vol % to 70 vol % based on an entire volume of the margin layer.

2. The all-solid-state battery of claim 1, wherein:
the aluminosilicate particles have an average particle size of 1 μm to 5 μm.

3. The all-solid-state battery of claim 1, wherein:
the ceramic glass contains at least one selected from the group consisting of silicon (Si) oxide, boron (B) oxide, sodium (Na) oxide, barium (Ba) oxide, zinc (Zn) oxide, aluminum (Al) oxide, and combinations thereof.

4. The all-solid-state battery of claim 1, wherein:
the ceramic glass that is included in an amount of 10 vol % to 70 vol % based on the entire volume of the margin layer.

5. The all-solid-state battery of claim 1, wherein:
a volume ratio of the aluminosilicate particles to the ceramic glass is 10:90 to 90:10.

6. The all-solid-state battery of claim 1, wherein:
the margin layer further includes an insulating material including ceramic or a resin.

7. The all-solid-state battery of claim 6, wherein:
the ceramic contains at least one selected from the group consisting of aluminum nitride (AlN), beryllium oxide (BeO), boron nitride (BN), silicon (Si), silicon carbide (SiC), silicon nitride (Si₃N₄), gallium arsenide (GaAs), gallium nitride (GaN), barium titanate (BaTiO₃), a mixture thereof, and oxides or nitrides of thereof.

8. The all-solid-state battery of claim 6, wherein:
the resin includes at least one selected from the group consisting of polyethylene, polypropylene, polyethylene terephthalate (PET), polyurethane, polyimide, and combinations thereof.

9. The all-solid-state battery of claim 1, further comprising:
a cover layer disposed on one surface or both surfaces of the cell laminate in a stacking direction,
wherein the cover layer includes the aluminosilicate particles (Al₂SiO₅), and the ceramic glass that does not contain lithium.

10. The all-solid-state battery of claim 9, wherein:
the aluminosilicate particles are included in an amount of 10 vol % to 70 vol % based on an entire volume of the cover layer.

11. The all-solid-state battery of claim 9, wherein:
the ceramic is included in an amount of 10 vol % to 70 vol % based on an entire volume of the cover layer.

12. An all-solid-state battery comprising:
a cell laminate including a solid electrolyte layer; a positive electrode layer and a negative electrode layer disposed with the solid electrolyte layer interposed therebetween; and a margin layer disposed at at least one of edges of the positive electrode layer and the negative electrode layer in a lateral direction, and
a cover layer disposed on one surface or both surfaces of the cell laminate in a stacking direction,
wherein the margin layer or the cover layer includes aluminosilicate particles (Al₂SiO₅),
the margin layer or the cover layer includes ceramic glass that does not contain lithium, and
the aluminosilicate particles are included in an amount of 10 vol % to 70 vol % based on an entire volume of the margin layer or the entire cover layer.

13. The all-solid-state battery of claim 12, wherein:
the aluminosilicate particles have an average particle size of 1 μm to 5 μm.

14. The all-solid-state battery of claim 12, wherein:
the ceramic glass contains at least one selected from the group consisting of silicon (Si) oxide, boron (B) oxide, sodium (Na) oxide, barium (Ba) oxide, zinc (Zn) oxide, aluminum (Al) oxide, and combinations thereof.

15. The all-solid-state battery of claim 12, wherein:
the ceramic glass is included in an amount of 10 vol % to 70 vol % based on the entire volume of the margin layer or the entire volume of the cover layer.

16. The all-solid-state battery of claim 12, wherein:
a volume ratio between the aluminosilicate particles to the ceramic glass is 10:90 to 90:10.

17. The all-solid-state battery of claim 12, wherein:
the margin layer or the cover layer further includes an insulating material including ceramic or a resin.

18. The all-solid-state battery of claim 17, wherein:
the ceramic includes at least one selected from the group consisting of aluminum nitride (AlN), beryllium oxide (BeO), boron nitride (BN), silicon (Si), silicon carbide (SiC), silicon nitride (Si₃N₄), gallium arsenide (GaAs), gallium nitride (GaN), barium titanate (BaTiO₃), a mixture thereof, and oxides or nitrides thereof.

19. The all-solid-state battery of claim 17, wherein:
the resin includes at least one selected from the group consisting of polyethylene, polypropylene, polyethylene terephthalate (PET), polyurethane, polyimide, and combinations thereof.

20. A multilayer all-solid-state battery comprising:
a cell laminate including a plurality of solid electrolyte layers, a plurality of positive electrode layers and negative electrode layers alternately disposed with each of the plurality of solid electrolyte layers interposed therebetween, and margin layers disposed at edges of the positive electrode layers and the negative electrode layers in a lateral direction,
wherein the margin layers include aluminosilicate particles,
the margin layers include ceramic glass that does not contain lithium, and
the aluminosilicate particles are included in an amount of 10 vol % to 70 vol % based on an entire volume of the margin layers.
